(19) United States
(12) Patent Application Publication
(10) Pub. No.: US 2011/0254758 A1
(43) Pub. Date: Oct. 20, 2011

(54) Flex Design and Attach Method for Reducing Display Panel Periphery

(75) Inventors: Peng Cheng Lin, Cupertino, CA (US); Mithran Cheriyan Mathew, Mountain View, CA (US)

(73) Assignee: QUALCOMM MEMS TECHNOLOGIES, INC., San Diego, CA (US)

(21) Appl. No.: 12/763,025

(22) Filed: Apr. 19, 2010

(51) Int. Cl. G09G 3/34; H01J 9/00; H01J 9/20

(52) U.S. Cl. 345/84; 445/24; 445/67

(57) ABSTRACT

Various embodiments described herein involve making connections with the display leads on more than one side of the display array, e.g., on 2 sides, 3 sides or all 4 sides of the display array. By making connections with the display leads on more than one side of the display array, the available area for bonding leads and control circuitry may be increased. The driver chip(s), discrete components, and other active components necessary for addressing the display panel may be attached to the top or the bottom of a flexible printed circuit (“FPC”) or a similar device. Some embodiments involve attaching an FPC to the display such that that the backplate is substantially encased by the FPC.

### FIELD OF THE INVENTION

This application relates generally to display technology and more specifically to circuitry for controlling displays.

### DESCRIPTION OF RELATED TECHNOLOGY

In general, consumers of portable devices having video capability would like to have the display occupy as much of the front surface of the portable device as possible. Accordingly, there is continued pressure for designers and manufacturers to reduce the display panel periphery (also referred to herein as “ledges”), used for display routing outside the active area of the display, in order to proportionately increase the active area of the display relative to the total front surface area. Consumers also want the portable displays to have increasingly higher resolution. Higher resolution displays require increased numbers of leads to conduct signals to the active area of the display. Increasing the number of leads means that more leads need to be connected to a driver chip, routed around the corners of the display, etc. Accordingly, the push for increased display resolution makes it increasingly difficult to reduce the display panel periphery. It would be desirable to provide improved methods and devices that can address these issues.

### SUMMARY

Improved devices and methods are provided herein. Various embodiments described herein involve making connections with the display leads on more than one side of the display array, e.g., on 2 sides, 3 sides or all 4 sides of the display array. Although various embodiments described herein involve making connections with the display leads with a flexible printed circuit (“FPC”), other devices may be used for making such connections. As such, use of the term “FPC” in such examples shall not limit the scope of the described embodiments.

By making connections with the display leads on more than one side of the display array, the available area for bonding the FPC may be increased. In such embodiments, the large ledge that was previously necessary for attaching a driver chip directly to the backplate in chip on glass (“COG”) implementations may be eliminated. Moreover, COG implementations involve routing across multiple ledges of the display substrate before reaching the display array. By routing on the FPC, the trace lengths and resistance may be substantially lower.

In some embodiments described herein, the driver chip(s), discrete components, and other components used for addressing the display panel may be attached to the top or the bottom of the FPC. The total driver output resistance, trace capacitance and mutual inductance may be reduced. Some embodiments involve attaching an FPC to the display such that that the backplate is substantially encased by the FPC.

Some embodiments described herein provide an apparatus that includes an array substrate and a display array disposed on the array substrate. The apparatus may include a plurality of leads extending outward from the display array. The plurality of leads may be disposed over the array substrate in a plurality of lead areas surrounding the display array. The device may further include the following elements: a backplate attached to the array substrate; a first processor configured to send drive signals to the display array; and a flexible substrate configured to convey the drive signals from the first processor to the plurality of leads. The flexible substrate may substantially enclose the backplate and may be attached to at least two of the lead areas.

The flexible substrate may be attached to each lead area of the plurality of lead areas. The first processor may be attached to a side of the flexible substrate proximate the backplate or attached to a distal side of the flexible substrate with respect to the backplate.

The plurality of leads may be disposed over the array substrate in two, three or four lead areas of two, three or four corresponding sides of the array substrate that are surrounding the display array. If there are two lead areas, the two corresponding sides may be adjacent sides of the display array or opposing sides of the display array. The plurality of leads may be disposed over the array substrate on all sides of the display array.

Alternative embodiments provide an apparatus that includes an array substrate, a display array disposed on the array substrate and a plurality of leads extending outward from the display array. The plurality of leads may be disposed over the array substrate in a plurality of lead areas surrounding the display array. The apparatus may include the following elements: a backplate attached to the array substrate; a first processor configured to send drive signals to the display array; and a flexible substrate configured to convey the drive signals from the first processor to the plurality of leads. The flexible substrate may be attached to each lead area of the plurality of lead areas. In some such embodiments, the flexible substrate may substantially enclose the backplate.

The plurality of leads may extend outward from the display array in each of two, three or four lead areas. The first processor may be attached to a side of the flexible substrate proximate the backplate or attached to a distal side of the flexible substrate with respect to the backplate.

The apparatus may be a component of another device, such as a portable display device. The portable display device may be, or may be part of, a portable media player, a smartphone, a personal digital assistant, a cellular telephone, a smartbook, a netbook or a smart phone.

The apparatus may also include a second processor configured to process image data and a memory device that is configured to communicate with the second processor. The apparatus may also comprise a controller configured to send at least a portion of the image data to the first processor. The apparatus may also include an input device configured to receive input data and to communicate the input data to the second processor. The apparatus may also include an image source module configured to send the image data to the second processor. The image source module may comprise a receiver, a transceiver and/or a transmitter.

Various methods are also described herein. Some such methods involve depositing a display array on an array substrate. The display array may comprise a plurality of leads disposed in a plurality of lead areas of the array substrate. Some such methods may involve attaching a backplate to the array substrate such that the backplate covers the display array but does not entirely cover the plurality of leads. The methods may also involve affixing a flexible substrate to the plurality of leads in each of the plurality of lead areas. The flexible substrate may be configured to convey drive signals from a processor to the plurality of leads. The method may involve coupling the processor and/or one or more passive components to the flexible substrate.

The affixing process may or may not comprise affixing the flexible substrate to the plurality of leads in each of the plurality of lead areas at substantially the same time. In some methods, the affixing process may involve a sequential process of affixing the flexible substrate to the plurality of leads in each of the plurality of lead areas. For example, the affixing process may comprise affixing first portions of the flexible substrate to leads in first opposing lead areas at a first time and affixing second portions of the flexible substrate to leads in second opposing lead areas at a second time. However, the affixing process may comprise affixing a first side portion of the flexible substrate to leads in a first lead area at a first time and affixing a second side portion of the flexible substrate to leads in a second and adjacent lead area at a second time. The affixing process may comprise substantially enclosing the backplate with the flexible substrate.

Some devices described herein include apparatus for depositing a display array on an array substrate, the display array comprising a plurality of leads disposed in a plurality of lead areas of the array substrate. The devices may further include apparatus for attaching a backplate to the array substrate such that the backplate covers the display array but does not entirely cover the plurality of leads. The devices may also include apparatus for affixing a flexible substrate to the plurality of leads in each of the plurality of lead areas. The flexible substrate may be configured to convey drive signals from a processor to the plurality of leads.

These and other methods of the invention may be implemented by various types of hardware, software, firmware, etc. For example, some features of the invention may be implemented, at least in part, by computer programs embodied in machine-readable media. The computer programs may, for example, include instructions for controlling one or more devices to fabricate a device as described herein. Alternatively, the computer programs may include instructions for operating, at least in part, the devices described herein.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 depicts a cross-section of a chip on glass (“COG”) configuration.

FIG. 9A depicts a bottom view of a “flex behind backplate” configuration according to some embodiments described herein.

FIG. 9B depicts a cross-sectional view of a configuration similar to that shown in FIG. 9A.

FIG. 10 depicts a bottom view of an alternative configuration.

FIG. 11 is flow chart that sets forth steps of fabricating devices according to some methods described herein.

FIG. 12 is flow chart that sets forth steps of fabricating devices according to some alternative methods described herein.

FIG. 13A depicts a bottom view of a dual “flex behind backplate” configuration according to some embodiments described herein.

FIG. 13B depicts a cross-sectional view of the configuration shown in FIG. 13A.

### DETAILED DESCRIPTION

While the present invention will be described with reference to a few specific embodiments, the description and specific embodiments are merely illustrative of the invention and are not to be construed as limiting the invention. Various modifications can be made to the described embodiments without departing from the true spirit and scope of the invention as defined by the appended claims. For example, the steps of methods shown and described herein are not necessarily performed in the order indicated. It should also be understood that the methods of the invention may include more or fewer steps than are indicated. In some implementations, steps described herein as separate steps may be combined. Conversely, what may be described herein as a single step may be implemented in multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa. Moreover, the specific materials, dimensions, etc., described herein are provided merely by way of example and are in no way limiting. The drawings referenced herein are not necessarily drawn to scale.

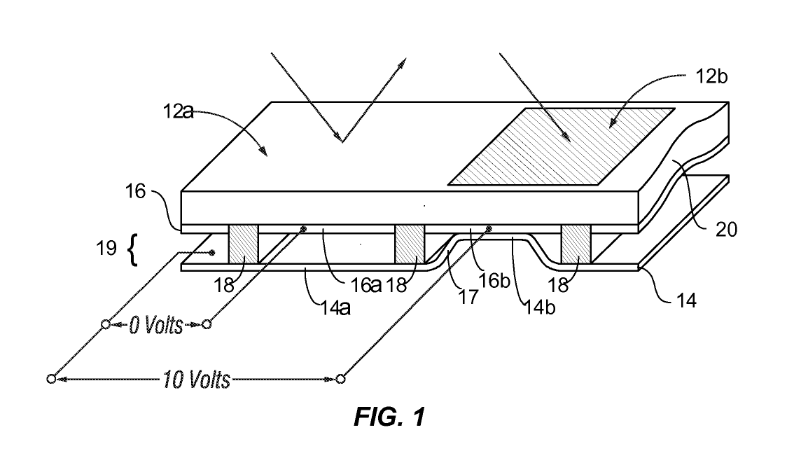

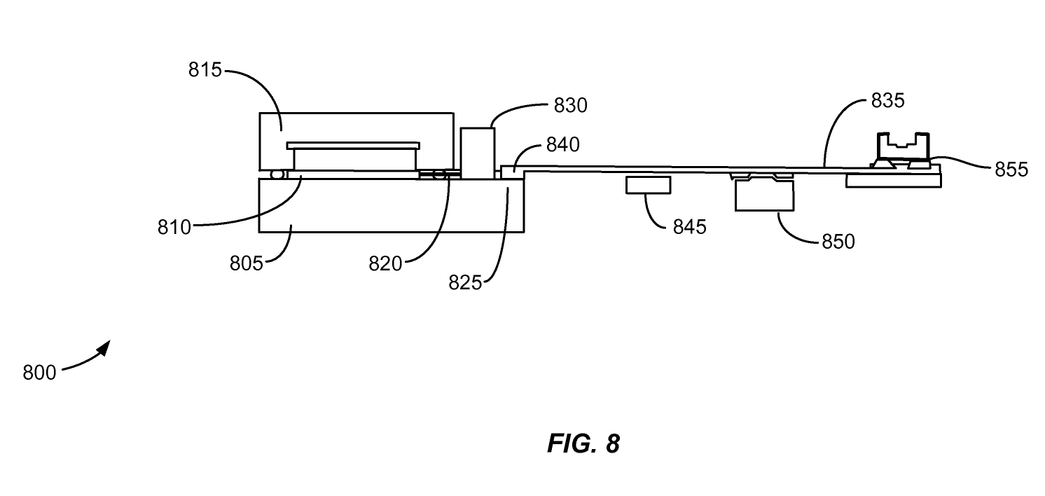

The methods and devices disclosed herein may apply generally to various types of displays, including but not limited to liquid crystal displays (“LCDs”), light emitting diode displays and displays involving microelectromechanical systems (“MEMS”), including but not limited to displays comprising interferometric modulators. However, the present assignee has been devoting substantial time and resources to the development of displays comprising interferometric modulators. Therefore, figures that provide some examples of interferometric modulators, their functions and their uses (FIGS. 1 through 7E) will be described first. Thereafter, systems and methods for reducing display panel periphery will be described with reference to FIGS. 8 et seq.

The embodiments described herein may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14 is illustrated in a relaxed position 14a at a predetermined distance from an optical stack 16a, which includes a partially reflective layer. In the interferometric modulator 12b on the right, the movable reflective layer 14 is illustrated in an actuated position 14b adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 μm, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

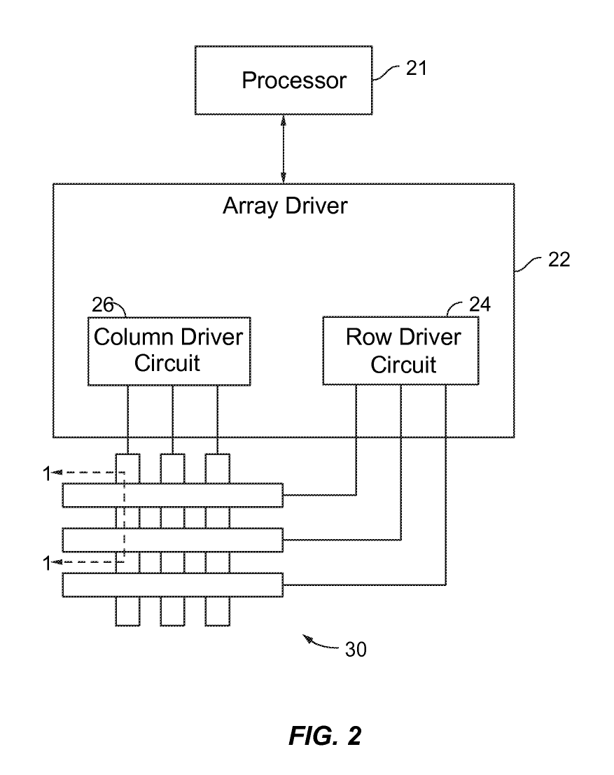

FIGS. 2 through 5 illustrate one exemplary process and system for using an array of interferometric modulators in a display application.

FIG. 2 is a system block diagram illustrating one embodiment of an electronic device that may incorporate interferometric modulators or other display apparatus. The electronic device may, for example, form part or all of a portable display device such as a portable media player, a smartphone, a personal digital assistant, a cellular telephone, a smartbook or a netbook. Here, the electronic device includes a processor 21, which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. Processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. Processor 21 and array driver 22 may sometimes be referred to herein as being “logic devices” and/or part of a “logic system.” The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

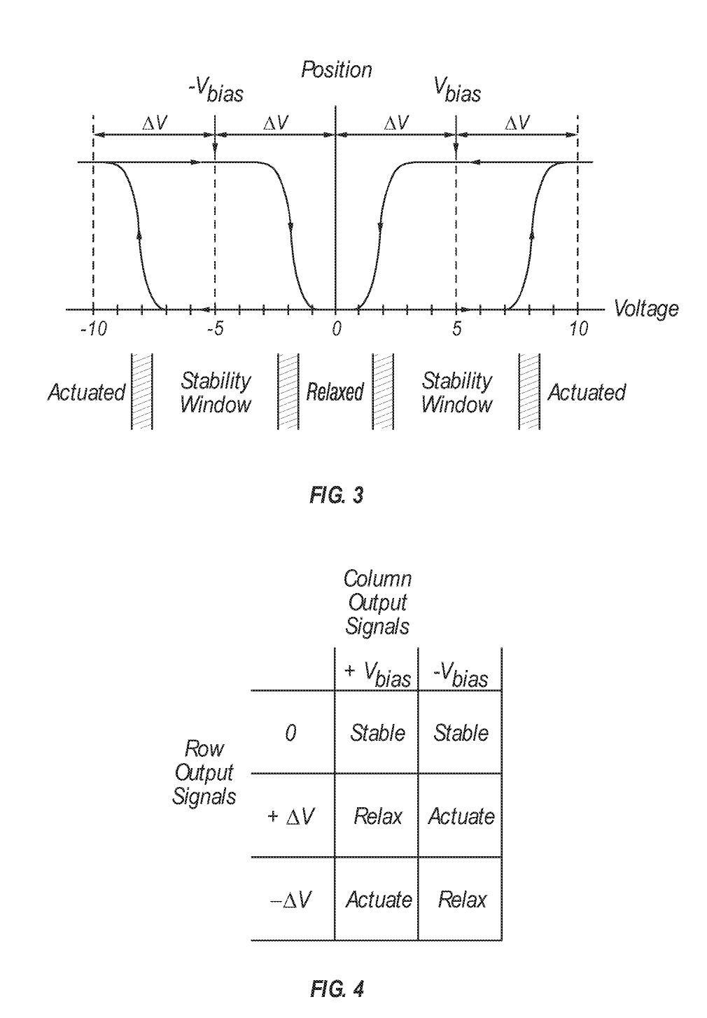

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

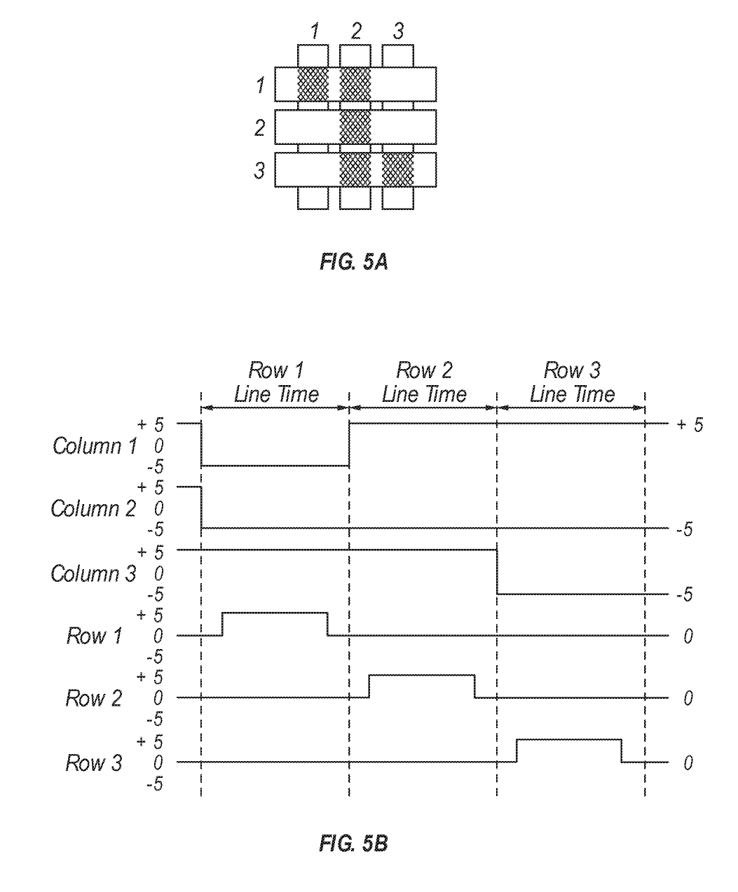

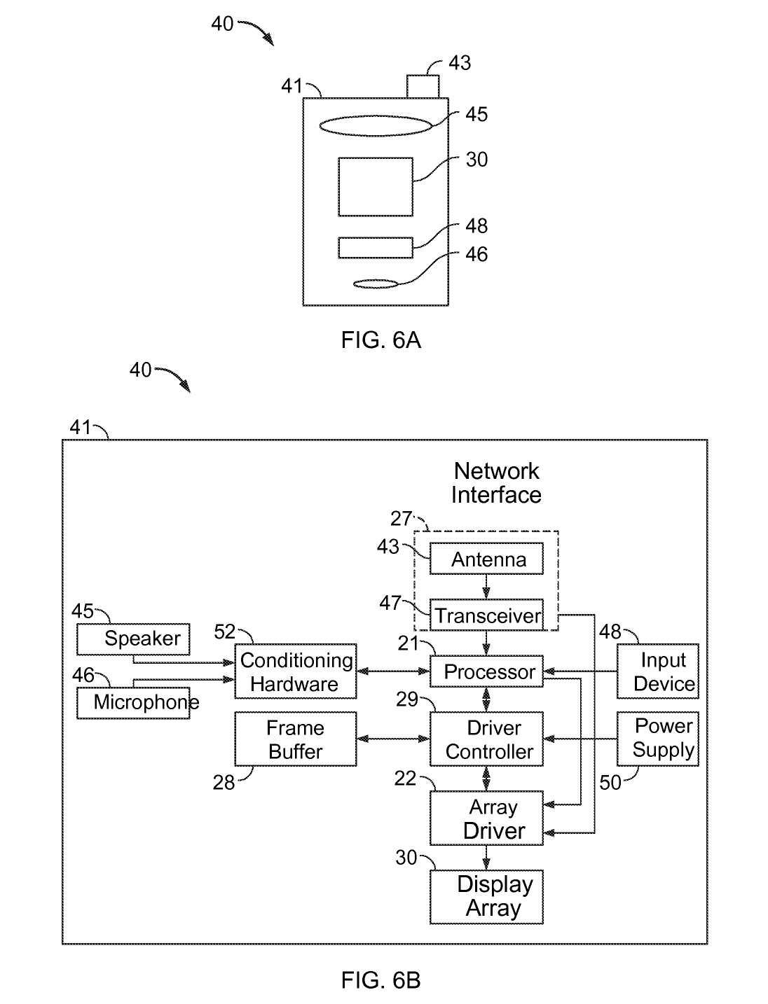

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −Vbias, and the appropriate row to +ΔV, which may correspond to −5 volts and +5 volts respectively Relaxing the pixel is accomplished by setting the appropriate column to +Vbias, and the appropriate row to the same +ΔV, producing a zero volt potential difference across the pixel. In those rows where the row voltage is held at zero volts, the pixels are stable in whatever state they were originally in, regardless of whether the column is at +Vbias, or −Vbias. As is also illustrated in FIG. 4, voltages of opposite polarity than those described above can be used, e.g., actuating a pixel can involve setting the appropriate column to +Vbias, and the appropriate row to −ΔV. In this embodiment, releasing the pixel is accomplished by setting the appropriate column to −Vbias, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

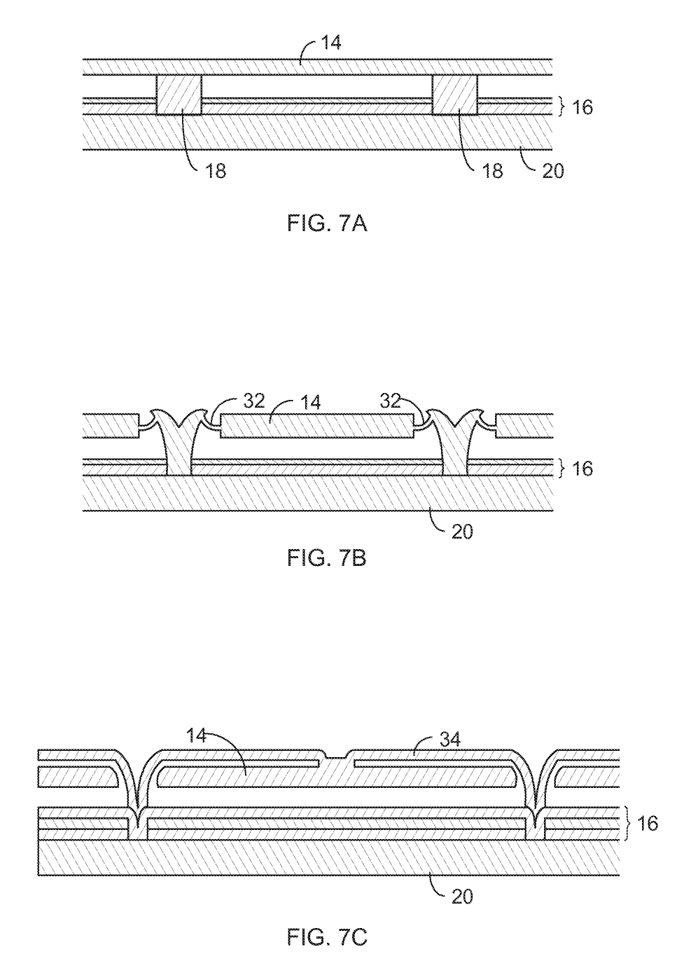

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device,. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. Conditioning hardware 52 and/or driver controller 29 may sometimes be referred to herein as part of the logic system. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or other logic device to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. For example, they may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

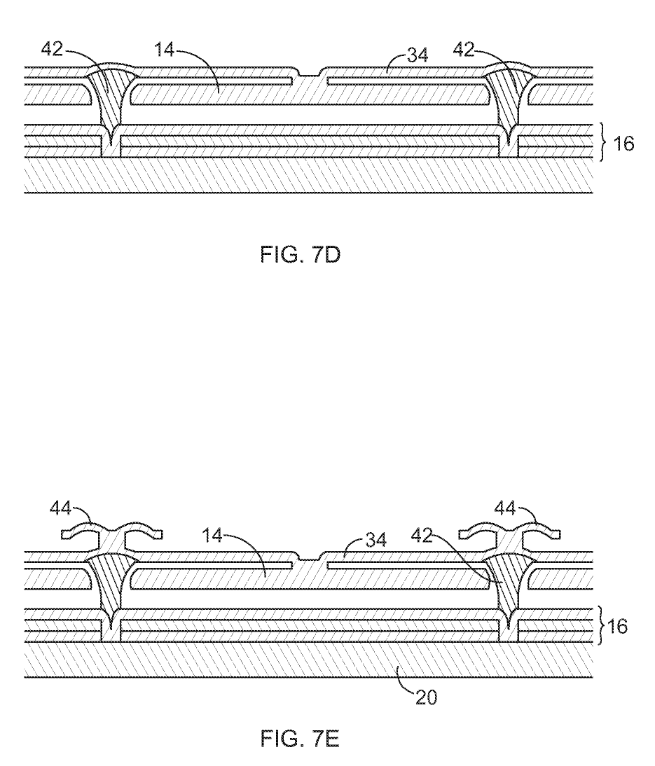

The details of the structure of interferometric modulators that operate in accordance with the principles set forth above may vary widely. For example, FIGS. 7A-7E illustrate five different embodiments of the movable reflective layer 14 and their supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Referring now to FIG. 8, an example of a chip on glass (“COG”) configuration will be described. Here, display device 800 includes array substrate 805 having display array 810 disposed thereon. Backplate 815 is attached to array substrate 805, thereby protecting display array 810.

Leads 820 extend outward from display array 810 onto ledge area 825 of array substrate 805. Leads 820 are connected to logic device 830, which is configured to provide signals for controlling display array 810. Logic device 830 may comprise, for example, a processor, a programmable logic device, etc., and may be referred to herein as a “driver chip” or the like.

Here, input signals are conveyed to logic device 830 via flexible printed circuit board (“FPC”) 835. In alternative implementations, input signals may be conveyed to logic device 830 via another type of flexible substrate having similar properties. In this example, FPC 835 comprises flexible material with wiring and connection pads, provided on the edge, that are configured to be conductive with the wiring.

FPC 835 may be fabricated, for example, by laminating a conductive foil, such as a copper foil, to a substrate and joining the layers with adhesive, or with the application of heat and pressure. FPC 835 may have one or more conductive layers as well as circuitry on one side or both sides. FPC 835 may include insulating layers, adhesive layers, encapsulating layers, stiffening layers, etc., according to the particular implementation. The flexible portion of FPC 835 may comprise, e.g., a polyimide or a similar type of thermoplastic material, such as a polyetherimide or polybutylene terphthalate.

Various components are mounted on FPC 835, including passive components 845, discrete components 850 and connector 855. Passive components 845 may include capacitors (e.g., for applying a voltage shift to input signals), resistors and/or inductors. Discrete components 850 may include passive or active components. In this example, connector 855 comprises a surface mount technology (“SMT”) connector. Here, connection pad 840 includes an adhesive anisotropic conductive film (“ACF”) for attaching FPC 835 to ledge area 825 and the input leads of logic device 830. However, an FPC may be attached to array substrate by other means, such as by other types of adhesive material, soldering, etc.

In this COG configuration, ledge area 825 needs to be large enough to accommodate both logic device 830 and connection pad 840. Moreover, leads from other portions of the display need to be routed around the display panel periphery to logic device 830. For example, if leads from row areas of the display array are adjacent to logic device 830, leads from column areas need to be routed around the perimeter of the display array to logic device 830.

It is not optimal to have such a large portion of the display device devoted to ledge 825 and other peripheral areas. As previously noted, consumers generally want a display to occupy as much of a portable device as possible. Accordingly, there is continued pressure for designers and manufacturers to reduce the display panel periphery in order to proportionately increase the active area of the display. Portable display devices also have increasingly higher resolution, which requires increased numbers of leads to conduct signals to the active area of the display. Increasing the number of leads means that more leads need to be connected to the driver chip(s), routed around the corners of the display, etc. Therefore, particularly when using designs such as that shown in FIG. 8, increasing the number of leads tends to increase the size of the display panel periphery.

In order to address such problems, various embodiments described herein involve making connections with the display leads on more than one side of the display array, e.g., on 2 sides, 3 sides or all 4 sides of the display array. By making connections with the display leads on more than one side of the display array, the available area for bonding leads to control circuitry may be increased. The driver chip(s) and other active or passive components may be attached to the top or the bottom of an FPC or the like. Accordingly, some such embodiments may be referred to herein as “chip on flex” or “COF.” Some embodiments involve attaching an FPC to the display such that that the backplate is substantially encased by the FPC.

By making connections with the display leads on more than one side of the display array, the available area for bonding the FPC may be increased. In such embodiments, the large ledge that was previously necessary for attaching a driver chip directly to the backplate in chip on glass (“COG”) implementations may be eliminated. Moreover, by routing on the FPC, the trace lengths and resistance may be substantially lower, as compared with those of COG implementations that involve routing across multiple ledges of the display substrate before reaching the display array. Accordingly, the total driver output resistance and other transmission line effects may be reduced.

In addition, it can be advantageous to have a COF apparatus, including the driver chip(s) and other components, that has been pre-tested and is known to be functioning properly. Having a “known good” COF apparatus available for attaching to a display substrate can simplify trouble shooting and de-bugging the display device.

Rework expenses may also be reduced. The logic devices, passives and other components of a COF apparatus may be relatively expensive. If a faulty display is formed that includes a COF apparatus that has previously been tested and is known to be functioning properly, the faulty display portion may be replaced. The COF apparatus, including the logic device(s) and other components, may be removed from the display portion and re-used. In contrast, if the driver chip of a conventional “chip on glass” device were removed, the driver chip would generally be too damaged by the removal process to function properly.

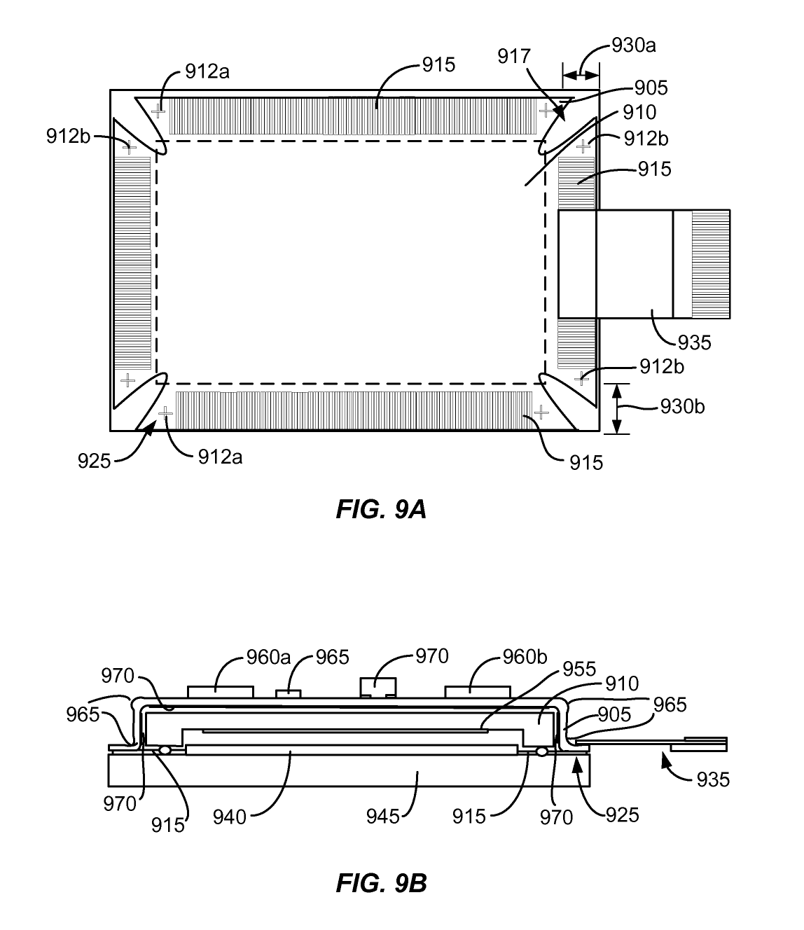

Some examples will now be described with reference to FIGS. 9A et seq. FIG. 9A depicts a bottom view of an embodiment in which COF apparatus 905 is substantially enclosing backplate 910. In this view, backplate 910 is covering the display array. However, backplate 910 does not entirely cover leads 915. Instead, leads 915 extend beyond backplate 910 on all four sides of the display array: leads 915 are disposed over array substrate 920 in four lead areas 925 surrounding the display array.

Such configurations allow COF apparatus 905 to be connected to leads 915 on 2 or more sides of active matrix area 915. In this example, COF apparatus 905 is connected to leads 915 on all four sides of active matrix area 915. Such configurations also allow ledge areas 930a and 930b to be relatively small, thereby proportionally increasing the active area of the display. In some examples, for a display having an active area of approximately 84 mm by 50 mm, ledge areas 930a may be 6 mm or less and ledge areas 930b may be 2 mm or less. In this example, relief features 917 allow the movement of each side portion of COF apparatus 905 to be de-coupled, at least to some extent, from the movement of adjacent side portions. These features, as well as alignment markers 912a and 912b, allow for more precise alignment of each side portion of COF apparatus 905 to the corresponding leads 915.

Connecting portion 935 extends outward from COF apparatus 905, allowing connectivity with, e.g., a logic system of a display device. In some embodiments, connecting portion 935 may comprise an extension of the FPC. In other embodiments, connecting portion 935 may comprise a separate connecting element attached to COF apparatus 905 via a connector, such as an SMT connector or a zero insertion force (“ZIF”) connector. In some implementations, connecting portion 935 may be located in another position, e.g., over another ledge portion or over backplate 910.

FIG. 9B depicts a cross-section of an embodiment like that illustrated in FIG. 9A. COF apparatus 905 extends over backplate 910 and is attached to leads 915 in lead areas 925. However, FIG. 9B includes some elements that are not visible in FIG. 9A. In this view, display array 940 may be seen. Display array 940 is disposed on array substrate 945. Leads 915 extend through sealant 950, which attaches backplate 910 to array substrate 945. Desiccant 955 is disposed on the inside of backplate 910 in this example.

FIG. 9B also depicts driver chips 960a and 960b, which are mounted on an outside surface of COF apparatus 905. Passive components 965 and discrete components 970 are also mounted on the outside surface of COF apparatus 905. However, such components may also be mounted on the inside surface of COF apparatus 905, as in the embodiment shown in FIG. 9A.

In this embodiment, COF apparatus 905 includes “pre-bend” areas 965, which have been bent or otherwise strained prior to the assembly process. Having areas 965 previously bent allows COF apparatus 905 to more readily conform to the shape of backplate 910 and lead areas 925. Here, COF apparatus 905 also includes stiffener portions 970 in areas adjacent to areas 965. Stiffener portions 970 may, for example, be formed of a polyimide (such as poly (4,4′-oxydiphenylene-pyromellitimide)) or of another type of polymer. Stiffener portions 970 may be any appropriate thickness. In some embodiments, stiffener portions 970 are between 35 and 250 microns in thickness. Some embodiments, such as those comprising a rigid laminate board, may be thicker than 250 microns.

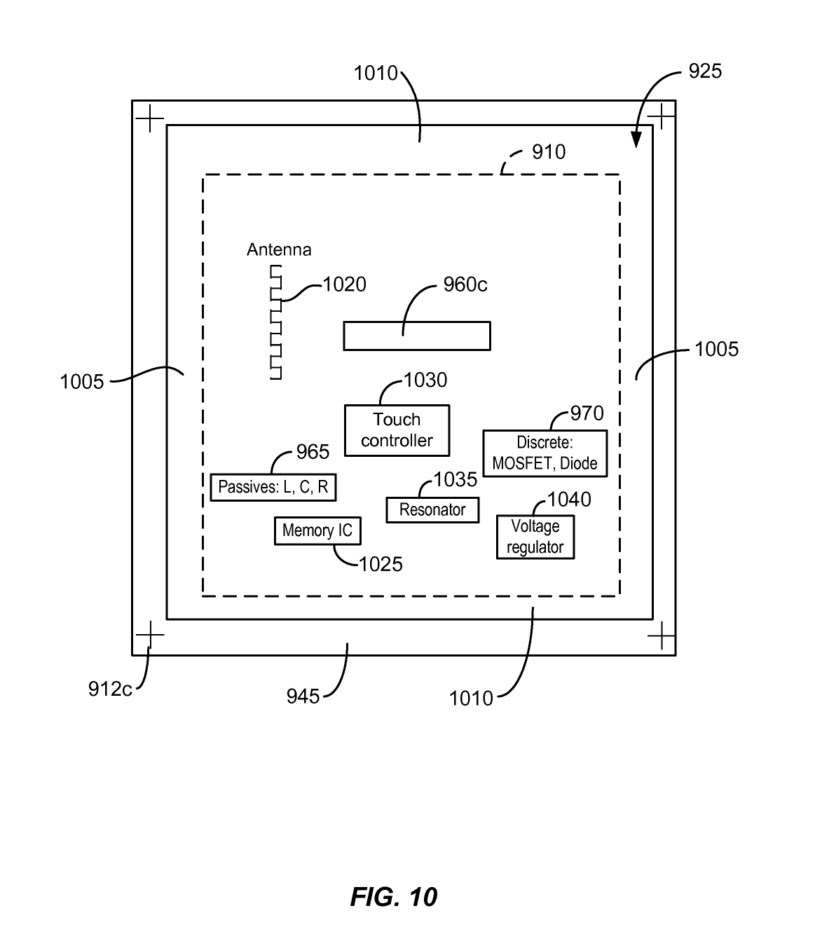

Some methods of device fabrication will now be described with reference to FIG. 10 et seq. FIG. 10 depicts an embodiment in which COF apparatus 905 substantially encloses backplate 910. COF apparatus 905 includes various active and passive components in this example. Here, COF apparatus 905 includes passive devices 965 (such as resistors, capacitors and/or inductors), discrete devices 970 (such as diodes, field-effect transistors, etc.) and an antenna 1020. In this example, COF apparatus 905 also includes one or more memory devices 1025, touch controller 1030 and resonator 1035. These devices are merely exemplary; other embodiments may include more devices, fewer devices or other types of devices.

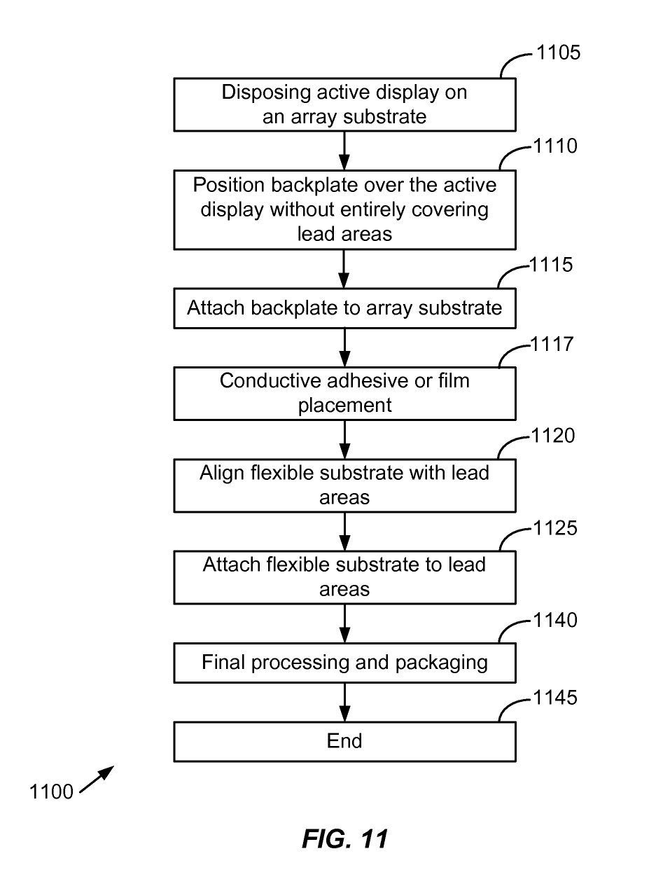

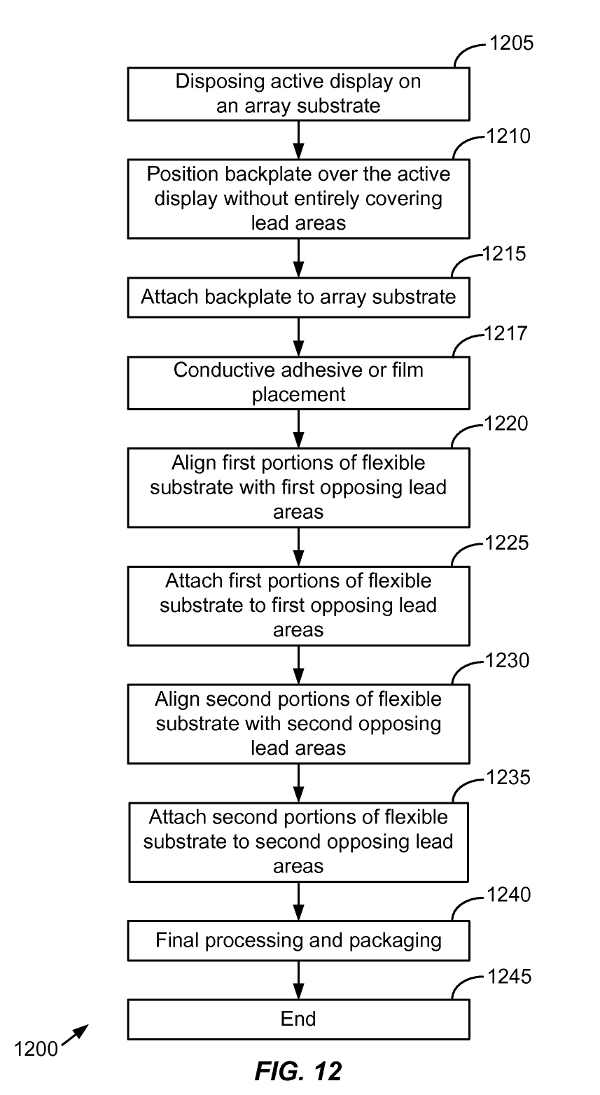

The processes outlined in FIGS. 11 and 12 involve, inter alia, attaching COF apparatus 905 to lead areas 925 of array substrate 945. As described in more detail below, in some implementations COF apparatus 905 may be attached to all of lead areas 925 at substantially the same time. However in alternative implementations, first portions of COF apparatus 905 may first be attached to first opposing lead areas (e.g., to lead areas 1005) and then second portions of COF apparatus 905 may be attached to second opposing lead areas (e.g., to lead areas 1010).

In other implementations, a first side portion of COF apparatus 905 may be attached to first lead areas (e.g., to one of lead areas 1005) and then a second side portion of COF apparatus 905 may be attached to a second and adjacent lead area (e.g., to one of lead areas 1010). Then, a third side portion of COF apparatus 905 may be attached either to opposing lead area 1005 or opposing lead area 1010. The remaining side portion of COF apparatus 905 may then be attached to the remaining lead area.

FIG. 10 also indicates registration marks 912c, which may be used as references for proper alignment of components during device fabrication. In this example, there are four registration marks 912c and they are disposed on array substrate 945. However, alternative embodiments may use more or fewer registration marks 912c, which may be disposed in the same locations indicated in FIG. 10 or in different locations.

Referring now to FIG. 11, method 1100 begins with a process of depositing a display array on an array substrate. (Step 1105.) This process may involve, for example, forming an array of interferometric modulators on an array substrate. However, the methods described herein also apply various other types of displays, including but not limited to LCDs and light emitting diode displays. Regardless of the type of display, leads from the display extend outward from the display array into lead areas over the array substrate.

In step 1110, a backplate (such as backplate 910 of FIG. 9B or FIG. 10) is positioned over the display array without entirely covering the lead areas. The positioning process may be enabled, at least in part, by reference to registration marks, such as registration marks 912c of FIG. 10. The backplate may then be attached to the array substrate, e.g., with an adhesive and/or sealant material. A sufficient portion of the lead areas should remain outside the area covered by the backplate for attaching pad areas of a COF apparatus, such as COF apparatus 905. A conductive adhesive or adhesive film is deposited on the lead areas. (Step 1117.) For example, an ACF adhesive (such as an ACF adhesive film) may be deposited on the lead areas.

The COF apparatus is then aligned with the lead areas. (Step 1120.) The alignment process may be enabled, at least in part, by reference to registration marks 912c and/or to other registration or reference marks. In some implementations, one or more of the leads and/or one or more areas of the COF apparatus may be separately identifiable and usable in the alignment process.

In step 1125, the COF apparatus is attached to the lead areas. The COF apparatus may be attached to the lead areas using any appropriate materials. For example, the COF apparatus may be attached using Connecting portion 935 may, in some implementations, be attached after the COF apparatus is attached to the lead areas. In alternative implementations, connecting portion 935 may be attached at an earlier time and moved aside when the COF apparatus is attached to the lead areas.

Final processing and packaging is then performed. (Step 1140.) For example, the resulting assembly may be tested and then incorporated into a display device. Alternatively, the resulting assembly may be tested and then packaged for shipping to a third party for future incorporation into a display device. The process ends in step 1145.

FIG. 12 is a flow chart that outlines steps of an alternative method of device fabrication. Steps 1205 through 1217 may be performed in substantially the same manner as steps 1105 through 1117. Accordingly, these steps will not be described again here.

However, method 1200 includes multiple steps of aligning and attaching the COF apparatus to the lead areas. In step 1220, first portions of the COF apparatus are aligned with first opposing portions of the lead areas. For example, corresponding portions of the COF apparatus may be aligned with, and then attached to (step 1225), opposing lead areas 1005 of FIG. 10. Corresponding portions of the COF apparatus may then be aligned with (step 1230), and then attached to (step 1235), opposing lead areas 1010 of FIG. 10.

Alternatively, step 1225 may involve aligning corresponding portions of the COF apparatus with opposing lead areas 1010. Step 1230 may comprise attaching corresponding portions of the COF apparatus with opposing lead areas 1010. Then, corresponding portions of the COF apparatus may be aligned with (step 1230) and attached to (step 1235) opposing lead areas 1005 of FIG. 10.

In either case, attaching the COF apparatus to first opposing lead areas, then second opposing lead areas may help prevent misalignment due to the stretching or other distortion of the COF apparatus during the attachment process. The forces involved in attaching the COF apparatus to opposing lead areas tend to distribute stress in a more predictable fashion, substantially perpendicular to the corresponding edges of the display.

Final processing and packaging is then performed. (Step 1240.) This process may, for example be substantially as described above with reference to step 1140. The process ends in step 1245.

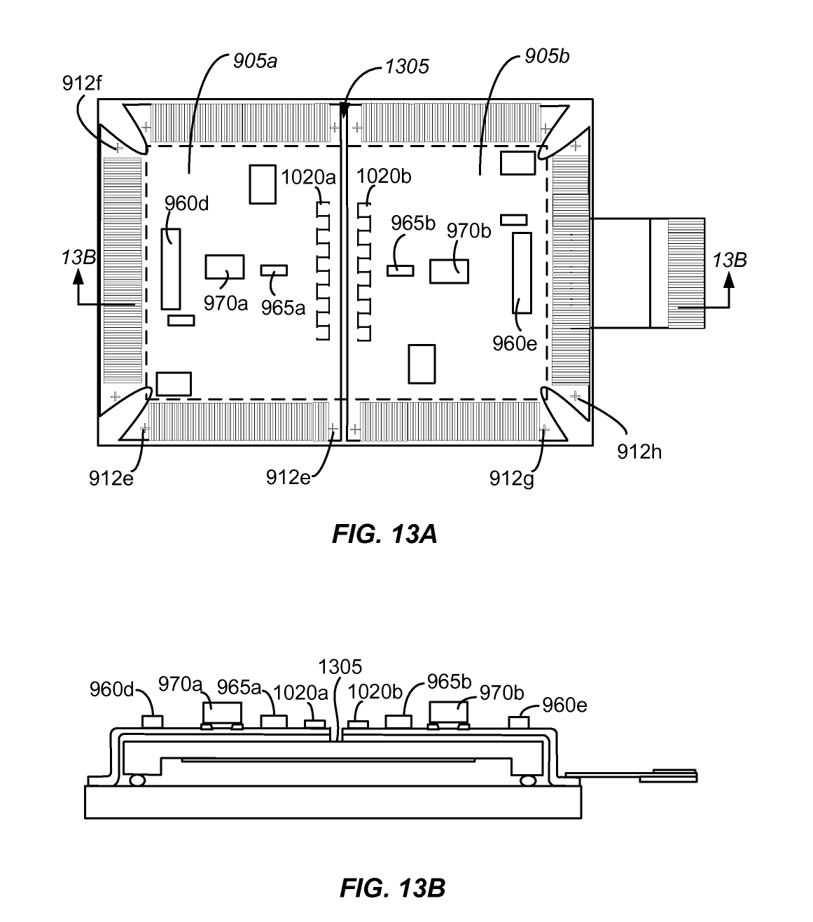

Instead of a single COF apparatus 905, some embodiments include 2 or more instances of COF apparatus 905. One such alternative embodiment is depicted in FIGS. 13A and 13B. The apparatus depicted here comprises two instances of COF apparatus 905. Instead of a single COF apparatus 905, this embodiment includes COF apparatus 905a and COF apparatus 905b. In this example, COF apparatus 905a and COF apparatus 905b are separated by gap 1305, but in other embodiments COF apparatus 905a and COF apparatus 905b may be disposed adjacent to one another.

Because COF apparatus 905a and COF apparatus 905b are separated, COF apparatus 905a has alignment markers 912e on a first side and alignment markers 912f on two opposing sides. COF apparatus 905b has alignment markers 912g and 912h. Accordingly, COF apparatus 905a and COF apparatus 905b may be coupled with a display during a single process or in two separate processes.

COF apparatus 905a includes a separate driver chip 960d, discrete devices 970a, passive devices 965a and antenna 1020a. Similarly, COF apparatus 905b has its own driver chip 960d, discrete devices 970a, passive devices 965a and antenna 1020a. Providing these devices separately allows faster addressing along shorter signal traces as compared to providing a single instance of these devices on a single COF apparatus. COF apparatus 905a and COF apparatus 905b may each be manufactured at a relatively lower cost and with a smaller form factor, as compared to the cost and form factor of a single COF apparatus.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

We claim:

1. An apparatus, comprising:
an array substrate;
a display array disposed on the array substrate;
a plurality of leads extending outward from the display array, the plurality of leads disposed over the array substrate in a plurality of lead areas surrounding the display array;
a backplate attached to the array substrate;
a first processor configured to send drive signals to the display array;
a flexible substrate configured to convey the drive signals from the first processor to the plurality of leads, the flexible substrate substantially enclosing the backplate and being attached to at least two of the plurality of lead areas.

2. The apparatus of claim 1, wherein the flexible substrate is attached to each lead area of the plurality of lead areas.

3. The apparatus of claim 1, wherein the first processor is attached to a side of the flexible substrate proximate the backplate.

4. The apparatus of claim 1, wherein the first processor is attached to a distal side of the flexible substrate with respect to the backplate.

5. The apparatus of claim 1, wherein the plurality of leads are disposed over the array substrate in four lead areas in four sides of the array substrate that are surrounding the display array.

6. The apparatus of claim 1, wherein the plurality of leads are disposed over the array substrate on all sides of the display array.

7. The apparatus of claim 1, wherein the plurality of leads are disposed over the array substrate in two lead areas on two sides of the display array.

8. The apparatus of claim 1, wherein the plurality of leads are disposed over the array substrate in three lead areas on three sides of the display array.

9. The apparatus of claim 7, wherein the two sides are adjacent sides of the display array.

10. The apparatus of claim 7, wherein the two sides are opposing sides of the display array.

11. An apparatus, comprising:
an array substrate;
a display array disposed on the array substrate;
a plurality of leads extending outward from the display array, the plurality of leads disposed over the array substrate in a plurality of lead areas surrounding the display array;
a backplate attached to the array substrate;
a first processor configured to send drive signals to the display array;
a flexible substrate configured to convey the drive signals from the first processor to the plurality of leads, the flexible substrate being attached to each lead area of the plurality of lead areas.

12. The apparatus of claim 11, wherein the flexible substrate substantially encloses the backplate.

13. The apparatus of claim 11, wherein the plurality of leads extends outward from the display array in each of four lead areas.

14. The apparatus of claim 11, wherein the first processor is attached to a side of the flexible substrate proximate the backplate.

15. The apparatus of claim 11, wherein the first processor is attached to a distal side of the flexible substrate with respect to the backplate.

16. The apparatus of claim 11, further comprising:
a second processor is configured to process image data; and
a memory device that is configured to communicate with the second processor.

17. A portable display device comprising the apparatus of claim 11.

18. The apparatus of claim 16, further comprising a controller configured to send at least a portion of the image data to the first processor.

19. The apparatus of claim 16, further comprising an input device configured to receive input data and to communicate the input data to the second processor.

20. The apparatus of claim 16, further comprising an image source module configured to send the image data to the second processor.

21. A portable media player, smartphone, personal digital assistant, cellular telephone, smartbook or netbook comprising the portable display device of claim 17.

22. The apparatus of claim 20, wherein the image source module comprises at least one of a receiver, transceiver, and transmitter.

23. A method, comprising:
depositing a display array on an array substrate, the display array comprising a plurality of leads disposed in a plurality of lead areas of the array substrate;
attaching a backplate to the array substrate such that the backplate covers the display array but does not entirely cover the plurality of leads; and
affixing a flexible substrate to the plurality of leads in each of the plurality of lead areas, the flexible substrate configured to convey drive signals from a processor to the plurality of leads.

24. The method of claim 23, wherein the affixing process comprises affixing the flexible substrate to the plurality of leads in each of the plurality of lead areas at substantially the same time.

25. The method of claim 23, wherein the affixing process comprises affixing the flexible substrate to the plurality of leads in each of the plurality of lead areas in a sequential process.

26. The method of claim 23, wherein the affixing process comprises:
affixing first portions of the flexible substrate to leads in first opposing lead areas at a first time; and
affixing second portions of the flexible substrate to leads in second opposing lead areas at a second time.

27. The method of claim 23, wherein the affixing process comprises:
affixing a first side portion of the flexible substrate to leads in a first lead area at a first time; and
affixing a second side portion of the flexible substrate to leads in a second lead area at a second time, wherein the first lead area is adjacent to the second lead area.

28. The method of claim 23, wherein the affixing process comprises substantially enclosing the backplate with the flexible substrate.

29. The method of claim 23, further comprising coupling the processor to the flexible substrate.

30. The method of claim 23, further comprising coupling one or more passive components to the flexible substrate.

31. An apparatus, comprising:
means for depositing a display array on an array substrate, the display array comprising a plurality of leads disposed in a plurality of lead areas of the array substrate;
means for attaching a backplate to the array substrate such that the backplate covers the display array but does not entirely cover the plurality of leads; and
means for affixing a flexible substrate to the plurality of leads in each of the plurality of lead areas, the flexible substrate configured to convey drive signals from a processor to the plurality of leads.
